(19) United States
(12) Patent Application Publication
(10) Pub. No.: US 2010/0034049 A1
(43) Pub. Date: Feb. 11, 2010

(54) Adjustable Diffusing Coal Valve

(76) Inventors: Nicholas William Ferri, Apex, NC (US); David J. Earley, Cary, NC (US)

Correspondence Address: COATS & BENNETT, PLLC, 1400 Crescent Green, Suite 300, Cary, NC, 27518, US

(21) Appl. No.: 12/186,930

(22) Filed: Aug. 6, 2008

(51) Int. Cl. B01F 13/00

(52) U.S. Cl. 366/341; 366/348

(57) ABSTRACT

An adjustable, diffusing coal valve for use in controlling flow of air and pulverized fuel to a burner is disclosed. An exemplary embodiment comprises a conduit section having an inner cross-sectional area and a diffusing damper plate mounted to said conduit section and rotatable within the conduit section between an open position and a closed position. The diffusing damper plate has a periphery dimensioned to occupy a majority, but less than all, of said inner cross-sectional area when in the closed position, and includes a plurality of perforations distributed within an outer region of the plate, thus allowing coal particles to flow through the damper plate when it is in a closed or partly-closed position.

### TECHNICAL FIELD

The present invention relates generally to systems and assemblies for controlling the flow of air and fuel in conduits supplying coal-fired furnaces and boilers. More particularly, the present invention relates to an adjustable, diffusing damper assembly for use in such systems.

### BACKGROUND

A coal-fired furnace used in electrical power generation typically employs multiple burners in a single combustion chamber, each burner fed by a mixture of pulverized coal and air supplied through a network of conduits originating from one or more pulverizer mills. It is well known that balancing the fuel supply among the burners is essential to good performance, since imbalances in the flow of coal from the furnace's burner nozzles can cause problems such as NOₓ formation, incomplete combustion (loss-on-ignition), erosion and contamination of the combustion chamber, and the like. It is also well known that the two-phase flow of air and coal through the various conduits supplying the furnace is affected by a number of factors, including the dimensions and configurations of the conduits themselves, the characteristics of the fuel, and the design and installation of various distribution system components.

A variety of devices have been employed or proposed to balance the distribution of coal as it flows from a single pulverizer, through several branches, to the burner nozzles. These devices include so-called riffle boxes and various damper valves and orifice restrictor devices. For instance, Ohtani et al., U.S. Pat. No. 6,976,440, discloses an adjustable damper deployed within a conduit branch to balance fuel distribution between the two outlets of the branch. Other devices have been proposed specifically to combat problems caused by “roping,” or “laning,” which is the tendency of the solid particles in the air-coal stream to become concentrated, forming a rope-like strand. For example, Wark et al., U.S. Pat. No. 6,234,090 describes linear diffuser elements deployed across the inside of a coal conduit for diffusing the coal flow across the interior of the conduit. Similarly, Wark, U.S. Pat. No. 6,840,183 describes a diffuser insert, with a combination of radial and axial diffusion elements, for use near an elbow connection to a burner nozzle.

However, some of these devices, such as the riffle box, are not adjustable, thus providing no means for variably regulating coal and air flow through the system. Other devices, such as orifice restrictors, may suffer from clogging or wear caused by the coal flow, while others can actually cause wear, by diverting all or part of the flow of the pulverized coal against interior walls of the conduit. Furthermore, some of these devices are difficult to install. Accordingly, improved devices that are uncomplicated to install and that simultaneously provide for diffusing and balancing coal flow are needed.

### SUMMARY

Disclosed herein is an adjustable, diffusing coal valve for use in controlling flow of air and pulverized fuel to a burner. The device can be constructed for easy installation, and includes a perforated damper blade to diffuse the flow of coal and reduce roping and pipe erosion. The disclosed coal valve can be installed at any of several points in a coal distribution system, such as at a mill outlet, before and/or after one or more riffle boxes, and just before a burner inlet, to facilitate balancing of pulverized coal between multiple distribution conduits and the corresponding burners while avoiding roping, clogging, and erosion problems.

In an exemplary embodiment, an adjustable, diffusing coal valve assembly comprises a conduit section and a diffusing damper plate mounted within the conduit section and movable between an open position and a closed position. The diffusing damper plate has a periphery dimensioned to occupy a majority, but less than all, of said inner cross-sectional area when in the closed position. In some embodiments, the diffusing damper plate's periphery is dimensioned to occupy less than about 80% of the conduit's inner cross-sectional area when in the closed position, thus ensuring a gap between damper plate periphery and the interior walls of the conduit.

The diffusing damper plate also includes a plurality of perforations distributed within an outer region of the plate, thus allowing coal particles to flow through the damper plate when it is in a closed or partly-closed position. In some embodiments, the diffusing damper plate and its perforations are dimensioned so that between about 40% and about 60% of the inner cross-sectional area of the conduit is obstructed when the diffusing damper plate is in the closed position. The cumulative cross-sectional area of the perforations in some embodiments is between about 10% and about 20% of the area defined by the diffusing damper plate's periphery. In other embodiments, for instance where more diffusing but less damping is required, the cumulative cross-sectional area of the perforations may comprise as much as about 40% of the area defined by the diffusing damper plate's periphery.

In several embodiments, the diffusing damper plate is rotatably mounted within the conduit section to rotate between the open and closed positions, although other configurations are possible. The diffusing damper plate may be constructed in various ways—in some embodiments, for example, the diffusing damper plate comprises two planar sections rigidly attached to opposite sides of a central shaft. In others, the diffusing damper plate instead comprises a single planar section connected to a shaft to form a substantially planar rotatable plate. In some embodiments, the diffusing damper plate may be coated with an abrasion resistant material, such as tungsten carbide, to resist wear.

In some embodiments, a diffusing damper plate is rotatably mounted within a spoolpiece for installation in new or existing coal distribution systems. In other embodiments, a diffusing damper plate may be connected to a mounting flange configured to be disposed against the outside surface of a conduit, so that the diffusing damper plate is rotatable within an inner region of the conduit between an open and closed position when the mounting flange is disposed against the outside surface of the conduit. The latter embodiments may be installed without removal of a pipe section, in many instances.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIG. 1 illustrates an adjustable, diffusing damper assembly, according to some embodiments of the invention.

FIG. 2 illustrates an exemplary adjustable, diffusing damper assembly in a fully closed position.

FIG. 3 provides a side view of an adjustable, diffusible coal valve assembly according to some embodiments of the invention.

FIG. 4 illustrates the flow of coal particles through an exemplary diffusing damper assembly.

FIGS. 5A and 5B illustrate exemplary diffusing damper plate constructions.

FIG. 6 is a schematic diagram of a portion of a coal distribution system indicating several installation locations for coal valve assemblies according to the present invention.

FIG. 7 is another schematic diagram illustrating a portion of another coal distribution system.

### DETAILED DESCRIPTION

As discussed above, various devices are presently known for balancing the distribution of coal in a pulverized coal distribution system. Other known devices are designed to encourage a diffuse flow of coal through the system. However, none of the existing devices provide a solution that adequately provides for balancing coal distribution, by means of variably restricting the coal and air flow through a pipe, while simultaneously diffusing the coal throughout the pipe, thus reducing the potential for coal roping and pipe erosion.

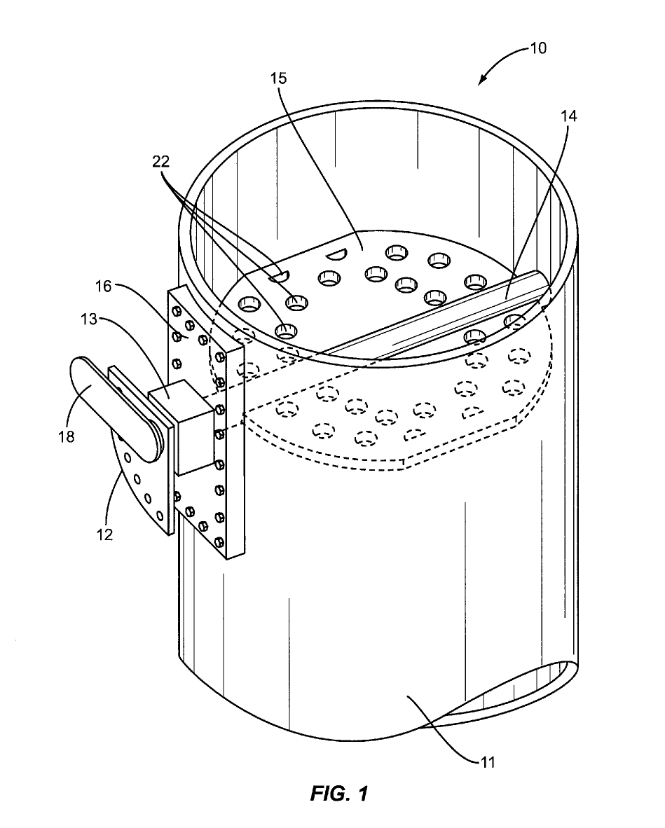

A novel diffusing damper apparatus 10, according to some embodiments of the present invention, is thus pictured in FIG. 1. Diffusing damper apparatus 10 includes a conduit section 11 and a diffusing damper plate 15 mounted within the conduit section 11 and rotatable, via shaft 14, between an open position and a closed position. In FIG. 1, diffusing damper plate 15 is shown in a fully closed position.

As will be discussed in further detail below, diffusing damper plate 15 has a periphery generally dimensioned to occupy a majority of the inner cross section of conduit 11 when in its closed position. However, the periphery of damper plate 15 is also dimensioned to provide for a gap between the conduit walls and the damper plate, to avoid clogging and excessive erosion of the walls of conduit 11. Diffusing damper plate 15 further comprises a plurality of perforations distributed within an outer region of damper plate 15, while the inner region is generally free of perforations. The perforations permit a substantial portion of the flowing coal particles to pass through the diffusing damper plate 15, rather than around it, when the damper plate 15 is in a closed or partially closed position, thus providing for a diffuse flow of coal without roping.

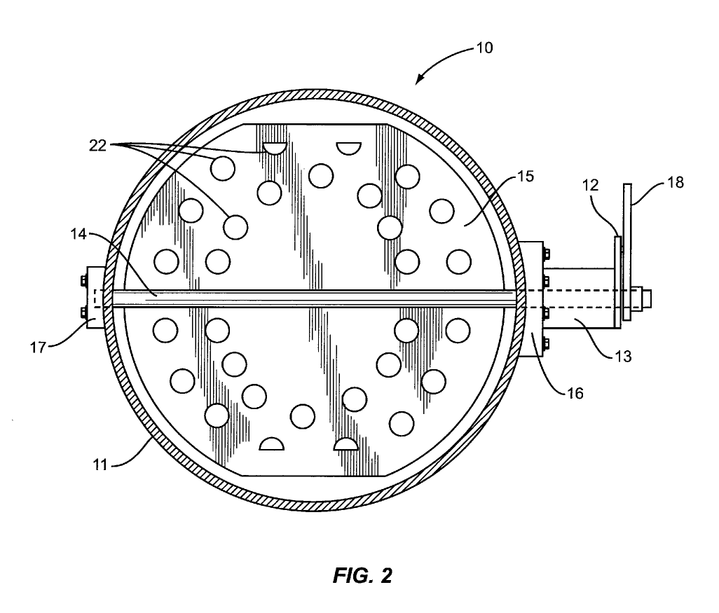

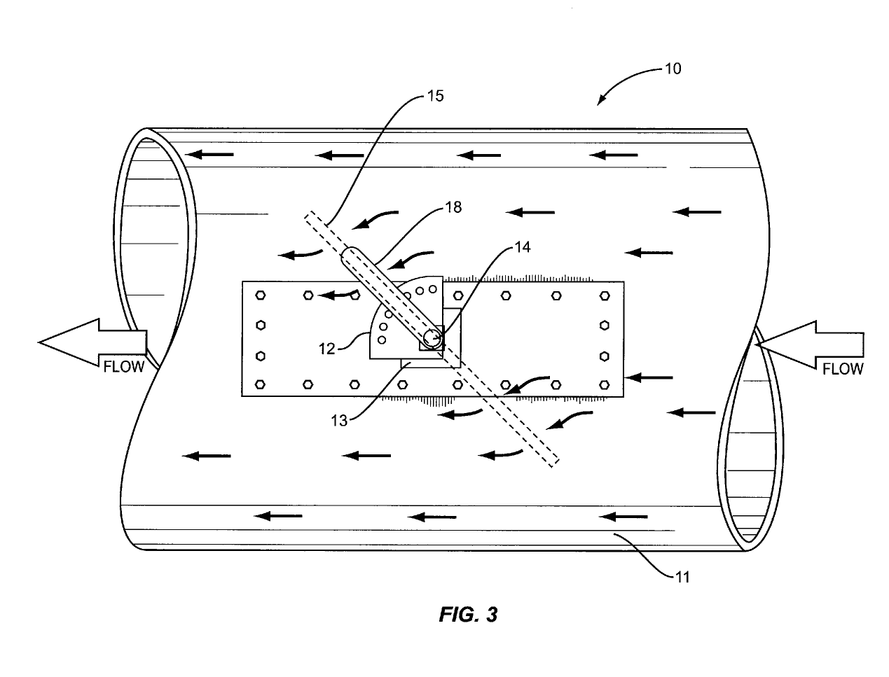

FIG. 1 illustrates a perspective view of an exemplary adjustable damping apparatus 10, with damper plate 15 in the fully closed position. FIG. 2 provides a view of a cross-sectional view of diffusing damper apparatus 10, again with damper plate 15 in the fully closed position. FIG. 3 provides a front view of apparatus 10; in this view the (hidden) damper plate 15 is in a partially closed position.

In FIGS. 2 and 3, details of an exemplary mounting system for damper plate 15 can be seen. In particular, as seen in FIG. 2, shaft 14 extends from one side of diffusing damper plate 15, through a wall of conduit 11, through a mounting flange 16, which is securely fastened to the conduit wall according to any conventional means, and through sealed bearing block 13, which is secured to mounting flange 16 and allows shaft 14 and diffusing damper plate 15 to be rotated within conduit 11. In some embodiments, shaft 14 also extends from a side of the damper plate 15 opposite the mounting flange and at least partially through the opposite conduit wall, for added support, although cantilevered installations (i.e., without this extension) are also possible. Retaining block 17, fastened to the wall of conduit 11, is provided in some embodiments for additional support of the extended shaft 14.

In some embodiments, a handle 18 is securely attached to shaft 14, allowing an operator to manually rotate the diffusing damper plate. Locking pin assembly 12 may also be provided to allow the diffusing damper plate 15 to be locked into any of several positions between fully closed, in which the generally planar surface of damper plate 15 is substantially orthogonal to the air flow through conduit 11, and fully open, in which the diffusing damper plate is substantially planar to the air flow through the conduit. Those skilled in the art will appreciate that the assembly illustrated in FIG. 2 may be readily modified, using conventional means, to provide for an electrically driven actuator, instead of handle 18, to allow automated rotation of the damper plate 15.

Diffusing damper plate 15 is a generally planar plate, connected to a rotating shaft, with a periphery dimensioned so as to substantially, but not completely, occupy the interior cross section of conduit 11 when in a closed position. As pictured, diffusing damper plate 15 is generally circular, although other shapes may be used. For instance, a rectangular damper plate may be preferred for installations in a rectangular conduit. Alternatively, appropriately dimensioned hexagonal or other multi-sided shapes may be used in conduits of various shapes.

A typical conduit 11 may have a nominal diameter of between about twelve and twenty-four inches, although diameters ranging eight to twenty-eight inches are well known. As noted above, the periphery of diffusing damper plate 15 is dimensioned to substantially, occupy the interior cross-sectional area of conduit 11 when closed. Accordingly, a diffusing damper plate configured for use in a pipe having an interior diameter of fourteen inches, for example, might have a diameter of about 10.5 inches, thus providing a gap of about 1.75 inches around the periphery of the damper plate when the valve is in a closed position. Damper plates according to various embodiments of the present invention have a periphery dimensioned to occupy less than about 80% of the inner cross-sectional area of the conduit when closed, although a somewhat larger periphery may be acceptable in some cases. For example, a generally round damper plate having a diameter of 10.5 inches has a cross section of about 87 square inches. This constitutes about 56% of the cross section of a 15-inch conduit (with an inner diameter of about 14 inches). The same damper plate may be suitable for use in a conduit having a 12-inch inner diameter as well, in which case the damper's cross section constitutes about 76% of the conduit's cross-sectional area.

The gap between the damper plate and the wall reduces erosion of the pipe due to coal particles forced around the damper plate and into the pipe's interior walls. This erosion is a particular problem with prior art damper devices having solid blades. However, this problem is reduced with the diffusing damper devices discussed herein, since a substantial portion of the coal flow is permitted to pass through the damper plate when in the closed position, rather than around it. Thus, diffusing damper plate 15 also includes several perforations 22 distributed within the outer portion of the plate, as shown in FIGS. 1, 2 and 5.

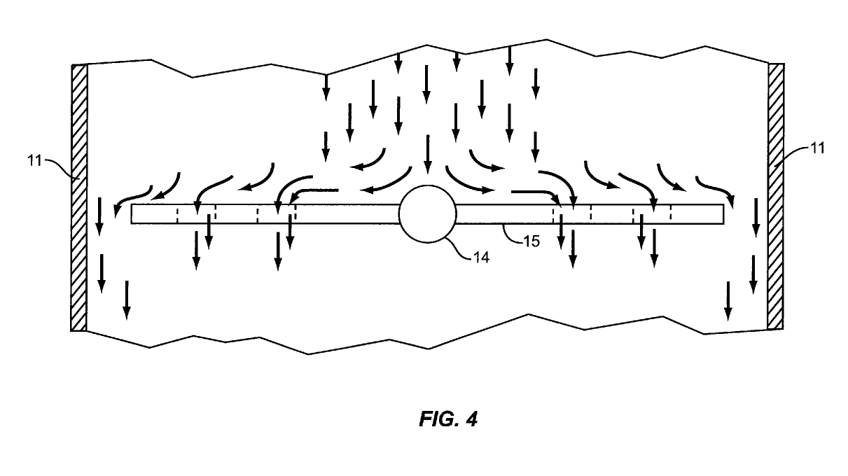

Perforations 22 permit the flow of air and pulverized coal through the damper plate as well as around it, scattering the pulverized particles and preventing the formation of coal “ropes,” which can cause burner performance problems, fuel balancing problems, and excessive erosion of the pipes. The inner region of the plate is generally free of perforations, breaking up any pre-existing ropes of pulverized coal and forcing a more even distribution of the pulverized coal fines. This can be seen in FIG. 4, which illustrates a cross-sectional view of a diffusing damper plate 15 in a closed position within a conduit 11. A relatively dense flow of coal particles (i.e., a coal rope) impinging upon the center of the damper plate 15 is broken apart by the perforation-free center of the plate, so that the flowing particles are forced through nearby perforations. The resulting flow below the damper plate 15 is more diffuse.

When in a closed position, the effective cross section of damper plate 15 is defined by its periphery as well as the number and dimensions of the perforations. For example, the 10.5-inch damper plate discussed above may include approximately 20 circular perforations one inch in diameter, having a cumulative area of about 15.7 square inches. Thus, the effective cross section of the 10.5-inch damper plate is about 71.3 square inches (87−15.7=71.3). This represents about 46% of the interior cross section of a 14-inch inner-diameter pipe—thus, 46% of the pipe's cross section is obstructed by the damper plate when in a fully closed position. Those skilled in the art will appreciate that damper plates may have effective cross sections, compared to the interior cross section of the conduit, that vary from this figure. Accordingly, some embodiments of the present invention have diffusing damper plates and perforations that are dimensioned so that between about 40% and about 60% of the inner cross-sectional area of the conduit is obstructed when the diffusing damper plate is in the closed position.

The number, shape, and dimensions of the perforations 22 may vary, provided that the perforations cumulatively allow a substantial quantity of the coal flow to pass through the perforations, rather than around the damper, when the diffusing damper plate is fully closed. Perforations having diameters between three-fourths inch and one inch have been found to be suitable in a damper plate configured for use in a 14-inch conduit. A broader range of perforation sizes is also possible, depending at least in part on the size of the damper plate. The perforations may also be have any of a variety of cross sections (i.e., they need not be circular) and shapes (e.g., the perforations may be tapered, or penetrate the damper plate at an angle, or the like). In some embodiments the cumulative cross-sectional area of the perforations is between about 10% and 20% of the area defined by the periphery of the diffusing damper plate. For instance, the 10.5-inch damper plate described above has twenty one-inch perforations, which cumulatively account for about 18% of the area defined by the damper plate's periphery. Those skilled in the art will appreciate that the cumulative area of the perforations and the gap around the damper plate determines the maximum damping effect of the diffusing damper plate. Accordingly, in instances where more diffusing but less damping is desired, the cumulative cross-sectional area of the perforations may comprise as much as about 40% of the area defined by the diffusing damper plate's periphery.

In any event, in many embodiments the cumulative effect of the diffusing damper plate and its perforations is to obstruct roughly one-half of the interior cross section of the conduit when in a fully closed position. In some embodiments, therefore, the diffusing damper plate and its perforations are dimensioned so that between about 40% and about 60% of the conduit's inner cross section is obstructed when the damper is fully closed. In a fully open position, on the other hand, the diffusing damper plate's obstruction of the conduit is negligible. Accordingly, the damping effect of the diffusing damper plate may be varied by simply rotating the plate, facilitating balancing of coal distribution between several conduits supplying a furnace. FIG. 3, for example, shows diffusing damper plate 15 in a partially open position.

FIGS. 1-3 illustrate a diffusing damper apparatus assembly in which the damper plate 15 is rotatably mounted within the conduit 11. Those skilled in the art, however, will appreciate that other configurations are possible for mounting the damper plate 15 so that it is movable within the conduit 11 between an open position and a closed position. For example, some embodiments may comprise a sliding assembly, in which the damper plate slides, in grooves or slides installed in one or more sides of the conduit wall, from a closed position, in which the plane of the diffusing damper plate is generally orthogonal to the flow of air and coal, to an open position, in which the restriction of the flow is minimized.

Those skilled in the art will also appreciate that various approaches to installing the diffusing damper apparatuses discussed herein. One approach is to construct a “spoolpiece” comprising a section of appropriately sized conduit and the damper plate rotatably mounted within it. The spoolpiece may be installed into an existing pipe by removing a length of pipe and replacing it with the spoolpiece, using conventional methods for joining the spoolpiece.

To facilitate easier installation, some embodiments of the present invention may comprise a diffusing damper plate, as described above, coupled to a mounting flange configured for disposal against the outside surface of the target conduit. (In some embodiments, the interior side of the mounting flange may be curved, with a radius matching the outer radius of the target pipe. In others, a flat flange may be used, perhaps with a suitable gasket.) A shaft connected to (or forming part of) the damper plate extends through the mounting flange, and may be rotatably secured to the mounting flange using conventional means, such as a bearing and a retaining handle, or the like. The diffusing damper assembly may be installed in an existing conduit by simply cutting a slot in a conduit wall, along the axis of the conduit. The slot need only have a width slightly larger than the widest part of the damper plate assembly (including the shaft), and a length slightly longer than the diameter of the damper plate. Those skilled in the art will appreciate that the damper plate may thus be fitted through the slot, and the mounting flange then secured to the exterior conduit wall using conventional means. In some embodiments, a hole may be drilled in the conduit wall opposite the mounting flange to accommodate an extension of the shaft at least partly into the conduit wall, for additional support.

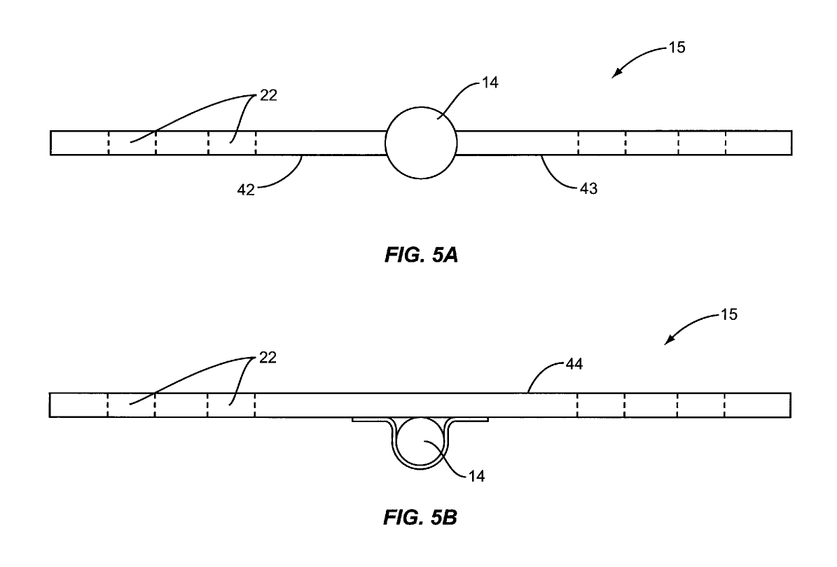

FIGS. 5A and 5B illustrate two possible constructions for a diffusing damper plate, according to some embodiments of the invention, although those skilled in the art will appreciate that other constructions are possible. FIG. 5A illustrates an exemplary damper plate 15 comprising a central shaft 14 and two planar sections 43 welded or otherwise rigidly attached to opposite sides of the central shaft 14. Perforations 22 may be cut with a laser or water jet, drilled, or punched through the outer region of planar sections 43. FIG. 5B illustrates an alternative construction, in which a single planar section 44 is welded or otherwise rigidly attached to the shaft 14. A plate thickness of about 3/16 inch has been demonstrated to provide adequate strength for a 10.5-inch diameter plate, although other thicknesses may be used, particularly for diffusing damper plates designed for very large or very small conduits. Likewise, a shaft diameter of about 0.75 inches has been shown to be suitable for a 10.5 damper plate, for use with pipes having inner diameters between about 12 inches and 14 inches. In some embodiments, the diffusing damper plate is constructed from hardened steel, e.g., with abrasion-resistant steel with a hardness greater than 400 on the Brinell scale. In some embodiments, the diffusing damper plate may be coated with an abrasion-resistant material such as tungsten carbide. The abrasion-resistant material resists erosion of the damper plate by the passing coal particles, extending its life.

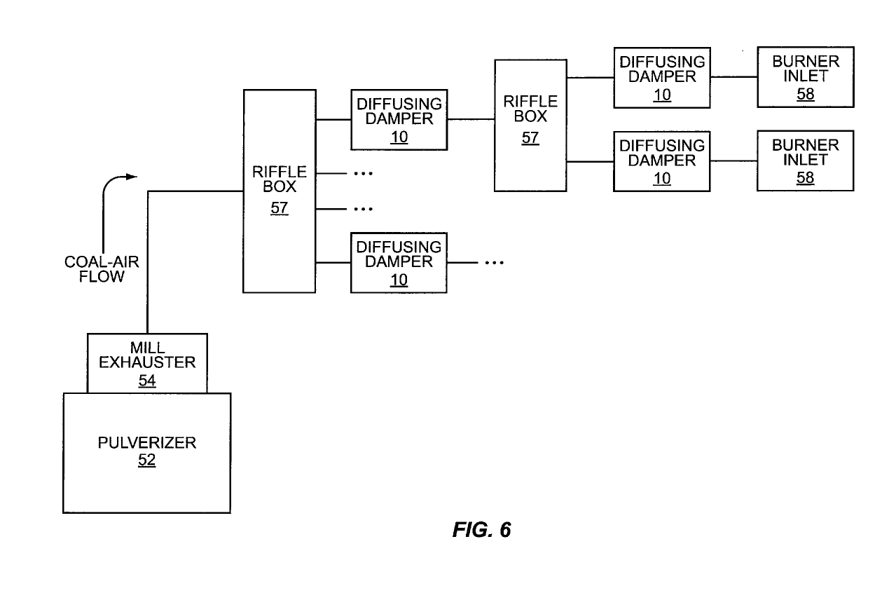

FIG. 6 is a simplified schematic diagram of a portion of a coal distribution system, such as might be found in a coal-fired electric power plant. In the system pictured in FIG. 6, diffusing damper apparatuses 10 are located at several points along the coal distribution path; those skilled in the art will appreciate that diffusing dampers as described herein may be advantageously employed at any of these points in various systems, or at one or more additional locations, depending on the particular layout and configuration of each system. In any event, in the system pictured in FIG. 6, the coal distribution begins at pulverizer 52, where a mixture of air and coal fines is injected into a system of pipes by mill exhauster 54. The mill exhauster 54 is typically followed by a riffle box 56, to divide the air and coal flow into two or more conduits. In some embodiments, diffusing dampers 10 may be installed at the outputs of riffle box 56, providing a means for variably damping the flow in one or more of the outputs relative to the others and thus balancing the coal distribution. The distribution system pictured in FIG. 6 also includes a second riffle box 57, positioned closer to the burner inlets 58, which provide the combustion chamber with the coal and air mixture. In various embodiments a diffusing damper apparatus 10 may be advantageously employed at the input to the riffle box 57 and/or at its outputs. Likewise, a diffusing damper apparatus 10 may be installed close to the burner inlet 58, to ensure a diffuse flow of pulverized coal fines into the combustion chamber.

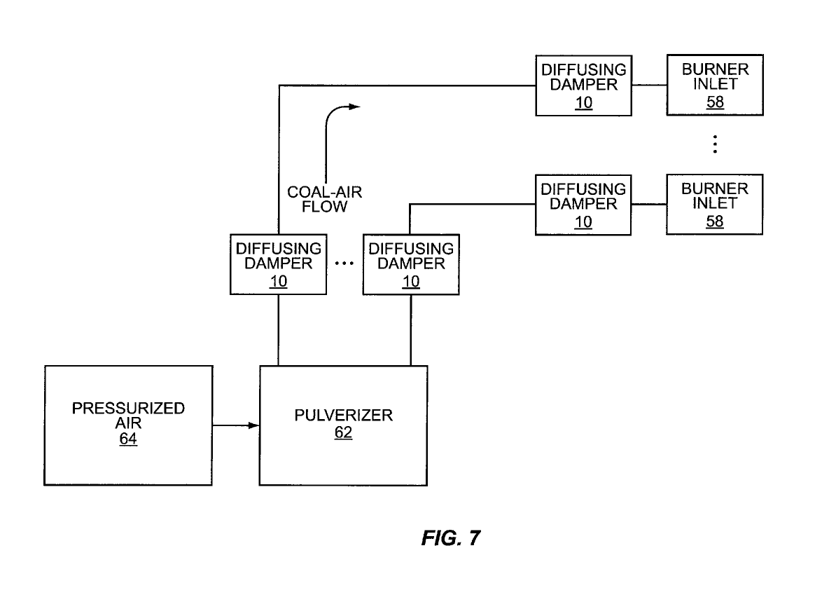

Those skilled in the art will appreciate that FIG. 6 illustrates only a portion of a typical coal distribution system. A typical system might, for instance, have five pulverizers 52, each coupled to a mill exhauster 54. Using riffle boxes and/or other branching devices, each of these mill exhausters 54 might supply as many as eight burner nozzles or more. Alternative systems might employ pressurized air for forcing the coal out of the pulverizer 52, as shown in FIG. 7, rather than an exhauster fan 54. In the schematic illustration of FIG. 7, a pulverizer 62 is supplied with pressurized air 64, forcing the pulverized coal fines into a plurality of mill outlets 65. In the pictured embodiment, a diffusing damper 10 is located close to the mill outlets 65, providing for balancing of the outputs and diffusion of the coal particles. Another diffusing damper 10 is illustrated near the ends of the each pipe run, just prior to entering the burners. Those skilled in the art will appreciate that various system configurations are possible, and that the diffusing damper apparatus described may be adapted for use in several locations of any of such systems, to ensure a diffused, balanced flow of coal throughout the system.

Indeed, the present invention may be carried out in other specific ways than those set forth without departing from the scope of the inventive techniques illustrated by the specific embodiments illustrated herein. Thus, the present invention is not limited to the features and advantages detailed in the foregoing description, nor is it limited by the accompanying drawings. Indeed, the present invention is limited only by the following claims and their legal equivalents.

What is claimed is:

1. An apparatus for use in controlling flow of air and pulverized fuel to a burner, the apparatus comprising:
a conduit section having an inner cross-sectional area; and
a diffusing damper plate mounted to said conduit section and movable within the conduit section between an open position and a closed position, wherein said diffusing damper plate has a periphery dimensioned to occupy a majority of said inner cross-sectional area but substantially less than all of said inner cross-sectional area when in the closed position, said diffusing damper plate comprising an inner region, an outer region concentric to said inner region, and a plurality of perforations distributed within said outer region.

2. The apparatus of claim 1, wherein the inner region of the diffusing damper plate is free of perforations.

3. The apparatus of claim 1, wherein the periphery of the diffusing damper plate is dimensioned to occupy less than about 80% of the inner cross-sectional area of the conduit section when in the closed position.

4. The apparatus of claim 1, wherein the diffusing damper plate and the perforations are dimensioned so that between about 40% and about 60% of the inner cross-sectional area is obstructed when the diffusing damper plate is in the closed position.

5. The apparatus of claim 1, wherein the cumulative cross-sectional area of the perforations is less than about 40% of the area defined by the periphery of the diffusing damper plate.

6. The apparatus of claim 5, wherein the cumulative cross-sectional area of the perforations is between about 10% and about 20% of the area defined by the periphery of the diffusing damper plate.

7. The apparatus of claim 1, wherein the diffusing damper plate is rotatably mounted within the conduit section to rotate between the open and closed positions.

8. The apparatus of claim 7, wherein the diffusing damper plate comprises two planar sections rigidly attached to opposite sides of a central shaft to form a substantially planar rotatable plate.

9. The apparatus of claim 7, wherein the diffusing damper plate comprises a single planar section connected to a shaft to form a substantially planar rotatable plate.

10. The apparatus of claim 1, wherein the diffusing damper plate is coated with an abrasion-resistant material.

11. An apparatus for use in controlling flow of air and pulverized fuel to a burner, the apparatus comprising:
a diffusing damper plate comprising an inner region, an outer region concentric to the inner region, and a plurality of perforations distributed within the outer region;
a mounting flange configured for disposal against the outside surface of a conduit; and
a first shaft section connected to the diffusing damper plate and extending through the mounting flange;
wherein the diffusing damper plate, mounting flange, and first shaft section are arranged so that the diffusing damper plate is rotatable within an inner region of the conduit between an open and closed position when the mounting flange is disposed against the outside surface of the conduit and wherein said diffusing damper plate has a periphery dimensioned to occupy a majority of the inner cross-sectional area of the conduit but substantially less than all of said inner cross-sectional area when in the closed position.

12. The apparatus of claim 11, wherein the inner region of the diffusing damper plate is free of perforations.

13. The apparatus of claim 11, wherein the periphery of the diffusing damper plate is dimensioned to occupy less than about 80% of the inner cross-sectional area of the conduit when in the closed position.

14. The apparatus of claim 11, wherein the diffusing damper plate and the perforations are dimensioned so that between about 40% and about 60% of the inner cross-sectional area of the conduit is obstructed when the diffusing damper plate is in the closed position.

15. The apparatus of claim 11, wherein the cumulative cross-sectional area of the perforations is less than about 40% of the area defined by the periphery of the diffusing damper plate.

16. The apparatus of claim 15, wherein the cumulative cross-sectional area of the perforations is between about 10% and about 20% of the area defined by the periphery of the diffusing damper plate.

17. The apparatus of claim 11, wherein the diffusing damper plate comprises two planar sections rigidly attached to opposite sides of the first shaft section to form a substantially planar rotating plate.

18. The apparatus of claim 11, wherein the diffusing damper plate comprises a single planar section rigidly connected to the first shaft section to form a substantially planar rotating plate.

19. The apparatus of claim 11, further comprising a second shaft section extending from an end of the diffusing damper plate opposite the mounting flange and configured to extend at least partially through a conduit wall.

20. A method of controlling flow of air and pulverized fuel through a conduit to a burner, the method comprising:
disposing a rotating diffusing damper plate within said conduit, wherein said diffusing damper plate has a periphery dimensioned to occupy a majority of said inner cross-sectional area but substantially less than all of said inner cross-sectional area when in the closed position, said diffusing damper plate comprising an inner region, an outer region concentric to said inner region, and a plurality of perforations distributed within said outer region, wherein said inner region is free of perforations; and
rotating the diffusing damper plate to an angular position between an open position, in which a planar surface of the diffusing damper plate is substantially planar to the air flow through the conduit, and a closed position, in which the planar surface is substantially orthogonal to the air flow through the conduit.
